(19) United States
(12) Patent Application Publication
(10) Pub. No.: US 2004/0076167 A1
(43) Pub. Date: Apr. 22, 2004

(54) Method for transmitting a signaling message in an ss#7 network

(76) Inventor: Gert Serroyen, Schelle (BE)

Correspondence Address: MORRISON & FOERSTER LLP, 1650 TYSONS BOULEVARD, SUITE 300, MCLEAN, VA, 22102, US

(21) Appl. No.: 10/433,951

(22) PCT Filed: Jan. 29, 2002
(86) PCT No.: PCT/DE02/00313

(30) Foreign Application Priority Data
Mar. 6, 2001 (DE) 101 10 679.3

(51) Int. Cl. H04L 12/28; H04L 12/56; H04J 3/16; H04J 3/22

(52) U.S. Cl. 370/401; 370/467

(57) ABSTRACT

The invention relates to a method for transmitting a signaling message (6-9, 12, 13; 24-35) in a network of the signaling system type No. 7 (SS#7) from a source location to a destination (1, 2, 4, 5; 20, 22, 23) by means of an SCCP (Signaling Connection Control Part) transmission protocol. The signaling message (6-9, 12, 13; 24-35) is addressed with a global title (14-19; 36-43) for identifying the destination (4, 5; 22, 23), and an additional item of address information (10, 11; 44, 45) is assigned to the global title (14, 15; 36, 37) before an address conversion of the global title is executed in the network of the signaling system type No. 7 in order to determine a suitable route for transmitting the signaling message (6-9, 12, 13; 24-35).

### CLAIM FOR PRIORITY

This application claims priority to International Application No. PCT/DE02/00313 which was published in the German language on Sep. 12, 2002.

### TECHNICAL FIELD OF THE INVENTION

The present invention relates to a method for transmitting a signaling message in a network of the signaling system type No 7 (SS#7) from a source location to a destination, by an SCCP (Signaling Connection Control Part) transmission protocol, whereby the signaling message is addressed with a global title for identifying the destination.

### BACKGROUND OF THE INVENTION

Methods for the transmission of a signaling message frequently make use of SCCP transmission protocols in an SS#7 network, which are arranged as the Signaling Connection Control Part (SCCP) augmenting the Message Transfer Part (MTP) in the SS#7 functions. The SCCP protocol is frequently employed in public, circuit-switched telephone networks and mobile radio systems. The SCCP protocol offers expanded information transmission capacity for a wide variety of uses within the signaling network device, such as the interrogation of a database in an intelligent network, the successful establishment of a switched connection between two subscribers to a telecommunications network, mobile roaming and handover services, etc.

When transmitting signaling messages, the users of the SCCP protocol can utilize a global address whose validity extends beyond the boundaries of a particular network in order to identify a destination. Addresses of this kind are known as global titles (GT), and are made up of a combination of numerals. The global title is used by transit nodes to determine the route to the next translation node. The requisite address translation for the global title (GTT, Global Title Translation) enables the routing of the signaling messages.

The SCCP protocol is an ITU-standardized Common Channel Signaling System 7 (CCS7) signaling protocol (ITU Q.711-Q.714), and is assigned to level 3 in the ISO reference model. The protocols to be assigned to level 3 serve to determine the route through the network from the source location to the destination, whereby the route can be present in a statically constant form, as enabled, for example, by the use of routing tables. The route may also be selected according to the current load on the network. In the latter case, a suitable route is selected for each logical connection, or even for each message to be sent, depending on the load situation affecting certain destination nodes at the time concerned.

The address translation of global titles with SCCP protocols is based on the address translation of the destination or the subscriber being called. This means that the global titles contain the numeric characters of the destination address. Until now, though, there has been no differentiation between the individual source location addresses. Telecommunications companies responsible for the transmission of cross-network traffic (IXC, Inter-Exchange Carriers) that offer SS#7 network transmission services for neighboring operators have been subject to the consequent disadvantage that no differentiation can be made in relation to the efficiency of the network according to the origin of the call.

### SUMMARY OF THE INVENTION

An object of the invention is to provide a method for transmitting signaling messages which permits differentiation of such signaling messages according to their origin.

According to an aspect of the invention an additional item of address information is assigned to the global title, before address translation of the global title takes place in the SS#7 network, to determine a suitable route for transmission of the signaling message. The addition of the extra item of address information enables differentiation in the various SS#7 address translations, so that a particular address translator can be selected, in order to determine the associated route. The route can thus be determined in such a way, depending on the additional item of address information, which indicates the origin of the signaling message, that more economical or more costly lines are employed. These lines may be characterized by greater or lesser performance in relation to the transmission of signaling messages. The IXC operators can thus offer the operators of other networks cheaper switching services, provided these operators do not require high-performance, high-quality services for the transmission of their signaling messages.

A further advantage according to the invention is that ambiguous call-number plans may be provided, if routing decisions cannot be made exclusively on the basis of the information from the global title, as, for example, in the case of call number overlapping of the subscriber called from call-numbers.

Further, if the structure of the call-number plan is unknown, an adjacent translation node can be selected on the basis of the origin information.

If the efficiency of the network is low, because all subscriber numbers have to be analyzed, route decisions can be made at an earlier stage of the transmission by using the origin address information.

By assigning an item of address information that identifies the operator at the source location to the global title, the selection of a very wide variety of rules is possible, depending on the origin of the signaling message. To this end, prior to the actual address translation of the global title, the item of address information for the global title containing the calling subscriber's address is added, in order then to be removed from the global title once more after the address translation. For this, a specific sequence of numbers, denoting the origin of the signaling message, is inserted into the number sequence of the global title of the calling subscriber, with the extra numbers being prefixed to the original sequence of numbers. After passing through an address translation function for the global title, these numbers are then removed from the global title once more. The additional item of address information can include any kind of parameter which contains information for transmission of the signaling transmission by the SCCP protocol.

### BRIEF DESCRIPTION OF THE DRAWINGS

FIG. 1 shows a first embodiment of the invention and

FIG. 2 shows a second embodiment of the invention.

### DETAILED DESCRIPTION OF THE PREFERRED EMBODIMENTS

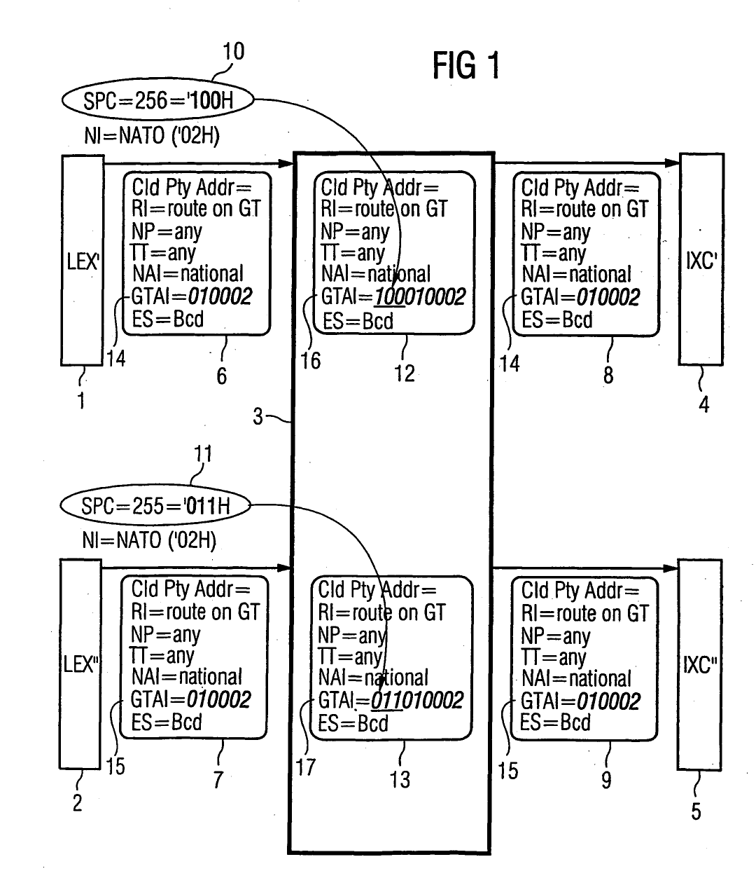

The first embodiment of the invention, as illustrated in FIG. 1, shows the selection of a suitable route for the transmission of a signaling message depending on the origin of the signaling message. As the source location, a location exchange 1 or 2 preferably sends a signaling message 6, 7 to a transit exchange 3, whereby each signaling message 6 and 7 preferably contains an initial global title 14 and 15 (GTAI) with a particular sequence of numbers for the address of the subscriber to be called. By adding an item of address information 10 and 11 identifying the source location and in the form of a sequence of numbers to the first global titles 14 and 15, the transit exchange may receive a second global title 16 and 17, with an address that serves to identify both the destination and the source location.

The resultant signaling messages 12 and 13 are subjected to the process performed by the global title translation (GTT) function. Here, the address information of the subscriber being called is analyzed, so as to select an appropriate route to the nearest gateway. After selection of the route, the additional item of address information 10 and 11 is once more removed from the second global title 16 and 17. The original initial global titles 14 and 15 with the original contents are thus received in the signaling messages 8 and 9. The actual transmission of the signaling message for switching of the call is then performed by the telecommunications company 4 and 5 (IXC).

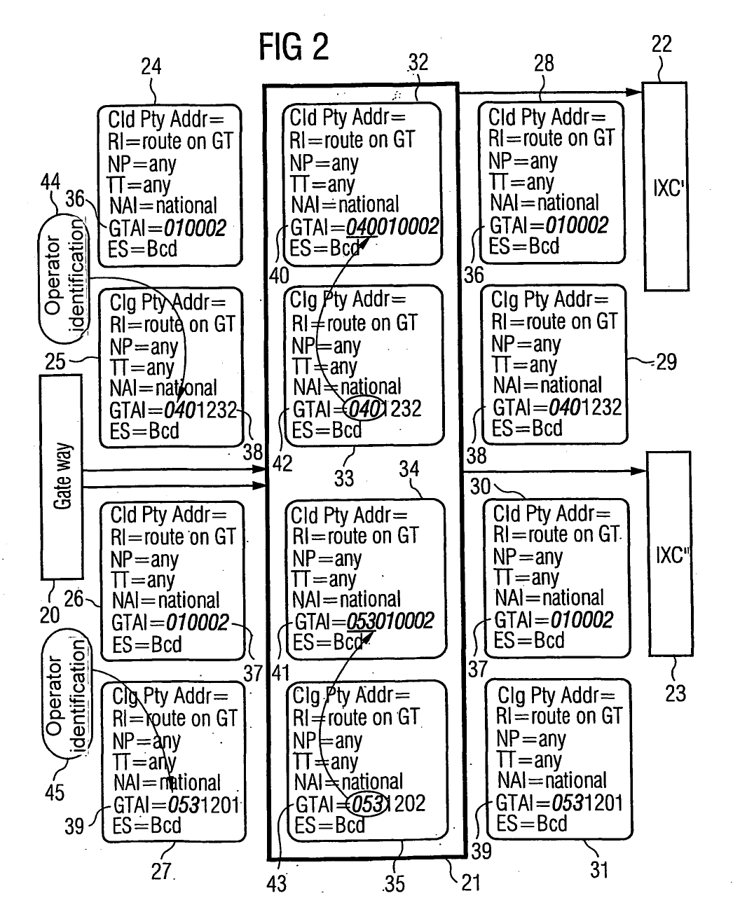

FIG. 2 shows a second embodiment of the invention, in which signaling messages 24-27 arriving via a gateway 20 are transmitted to a transit exchange 21. A further group of signaling messages 28-31 contains the signaling messages after they have passed through the address translation function. The signaling messages 32-35 are the messages during their passage through the address translation function. The first global title 36 and 37 contains a sequence of numbers comprising exclusively the address of the subscriber to be called. The second global title 38 and 39 holds, among other items, the sequence of numbers 44, 45 that identifies the operator from whom the call originates. In the second global title, these sequences of numbers are prefixed to the remaining numbers.

When passing through the address translation function of the global title in the transit exchange, the number sequences 44, 45 are transferred from signaling messages 33 and 35 to signaling messages 32 and 34. This gives rise to the third global titles 40 and 41, which now contain the item of address information for the location of origin, as well as that for the destination.

After the GTT function has analyzed the item of address information for the subscriber being called, and has selected a suitable route to the next gateway, the additional item of address information in the outgoing signaling messages 28 and 30, which denotes the origin of the call, is once more removed from the third global titles 40 and 41. The signaling messages are subsequently transmitted via telecommunications companies 22 and 23, for switching the calls.

The methods described in accordance with the invention may be employed not just for the addition of an item of address information indicating the origin, but also for the insertion of any kind of information important for transmissions of signaling messages.

1. A method for the transmission of a signaling message (6-9, 12, 13; 24-35) from a source location to a destination (1, 2, 4, 5; 20, 22, 23) in a signaling system type network No. 7 (SS#7), by means of an SCCP (Signaling Connection Control Part) transmission protocol, where the signaling message (6-9, 12, 13; 24-35) is addressed with a global title (14-17; 36-43) for identification of the destination (4, 5; 22, 23),
characterized in that
an additional item of address information (10, 11,; 44, 45) is assigned to the global title (14, 15; 36, 37), before address translation is performed on the global title in the signaling system type network No. 7 (SS#7), in order to determine a suitable route for transmission of the signaling message (6-9, 12, 13; 24-35):

2. A method according to claim 1,
characterized in that
the additional item of address information (10, 11; 40, 41) is an item of information (44, 45) belonging to a network operator in a network at the source location (20).

3. A method according to claim 1 or 2, and in particular claim 1,
characterized in that
the additional item of address information (10, 11; 44, 45) is an item of information (10, 11) belonging to an exchange at the source location (1, 2).

4. A method according to one of the preceding claims, in particular claim 2 or 3,
characterized in that
the item of information (10, 11,; 44, 45) is arranged as prefixed numbers in the global titles (16, 17; 40, 41).

5. A method according to one of the preceding claims,
characterized in that
after completion of address translation on the global title (16, 17; 40, 41), the additional item of address information (10, 11; 44, 45) is erased.
